(19) United States
(12) Patent Application Publication
(10) Pub. No.: US 2008/0068562 A1
(43) Pub. Date: Mar. 20, 2008

(54) IMAGE PROCESSING SYSTEM, IMAGE PROCESSING METHOD, AND PROGRAM PRODUCT THEREFOR

(75) Inventor: Kazutaka HIRATA, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/677,115

(22) Filed: Feb. 21, 2007

(30) Foreign Application Priority Data
Sep. 19, 2006 (JP) 2006-251992

(51) Int. Cl. G03B 23/00

(52) U.S. Cl. 353/25

(57) ABSTRACT

An image processing system includes: a projecting portion that projects image data; a first image recording portion that records a projection region of the projecting portion as first image data, at first resolution; a second image recording portion that records the projection region of the projection portion as second image data, at second resolution, which is higher than the first resolution; and an image processing portion that sends first image data at the first resolution and second image data at the second resolution to a terminal apparatus and outputs image data to be projected from the terminal apparatus to the projecting portion.

### BACKGROUND

1. Technical Field

This invention generally relates to an image processing system provided with a projector and a camera, for use in a remote instruction system, a remote conference system, or the like.

2. Related Art

For example, in a remote repairing system, remote maintenance system, remote medical system, remote conference system, or the like, there are needs for giving various instructions such as operating procedure or the like, from a remote terminal side to a real object side. As such a remote instruction system, by which an instruction can be made by the remote terminal side to the real object side, there is known a technique for projecting annotation image data onto a subject by means of a projector at the real object side, while the subject existent at the real object side is being recorded by a camcorder and such recorded image data is being sent to the remote terminal, the annotation image having been designated on the basis of recorded image data at a remote terminal.

### SUMMARY

According to an aspect of the present invention, there is an image processing system including: a projecting portion that projects image data; a first image recording portion that records a projection region of the projecting portion as first image data, at first resolution; a second image recording portion that records the projection region of the projection portion as second image data, at second resolution, which is higher than the first resolution; and an image processing portion that sends first image data at the first resolution and second image data at the second resolution to a terminal apparatus and outputs image data to be projected from the terminal apparatus to the projecting portion.

### BRIEF DESCRIPTION OF THE DRAWINGS

Exemplary embodiments of the present invention will be described in detail based on the following figures, wherein:

Exemplary embodiments of the present invention will be described in detail based on the following figures, wherein:

FIG. 1 shows a system configuration of a remote instruction system provided with an image processing system employed in an exemplary embodiment of the present invention;

FIG. 2 is a functional block diagram of an image processing apparatus;

FIG. 3 is a flowchart showing an example of communication processing of the image processing apparatus;

FIG. 4 is a flowchart showing an example of image processing of the image processing apparatus;

FIG. 5 is a flowchart showing an example of processing of a computer;

FIG. 6A and FIG. 6B are views showing examples of images projected onto the target;

FIG. 7A and FIG. 7B are views showing display examples of a display apparatus at the computer side;

FIG. 8 is a view showing an example of screen displaying high-definition image data on the display apparatus at the computer side;

FIG. 9 is a view showing another example of screen displaying the other high-definition image data on the display apparatus at the computer side;

FIG. 10 shows a system configuration of the remote instruction system where an image processing system employed in another exemplary embodiment of the present invention is used;

FIG. 11 shows a system configuration of the remote instruction system where an image processing system employed in yet another exemplary embodiment of the present invention is used;

FIG. 12 shows states of projection of annotation image data and a high-definition camera 30 or a camera 20A;

FIG. 13 shows a configuration of a camera and projector unit to a common lens;

FIG. 14A and FIG. 14B show examples of shape of a mirror unit 203; and

FIG. 15 shows another configuration of a camera and projector unit with a rotation unit.

### DETAILED DESCRIPTION

A description will now be given, with reference to the accompanying drawings, of exemplary embodiments of the present invention.

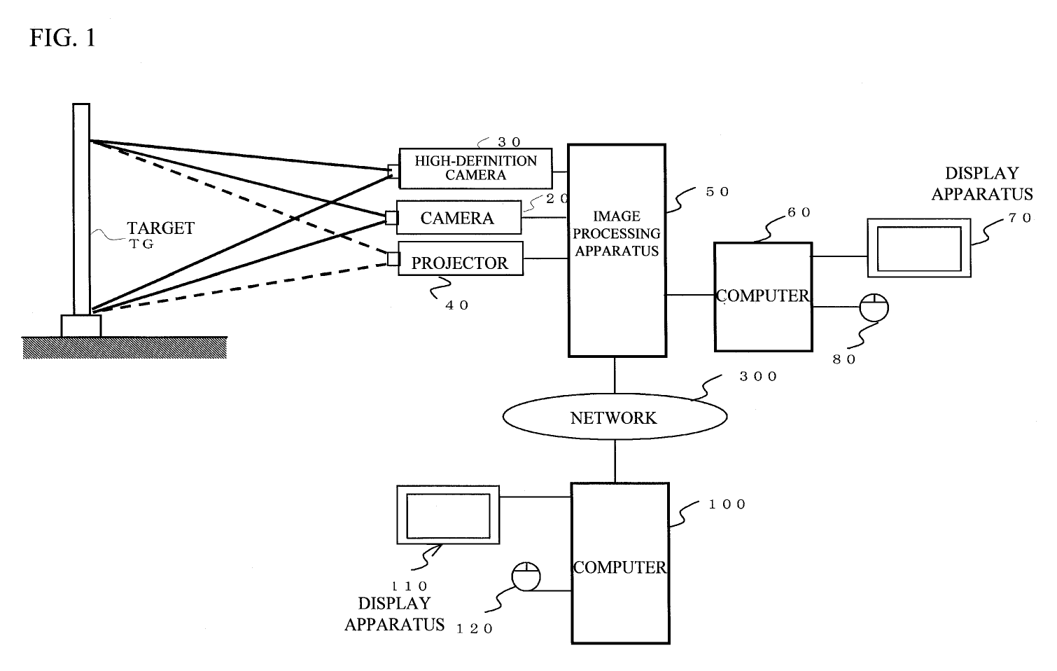

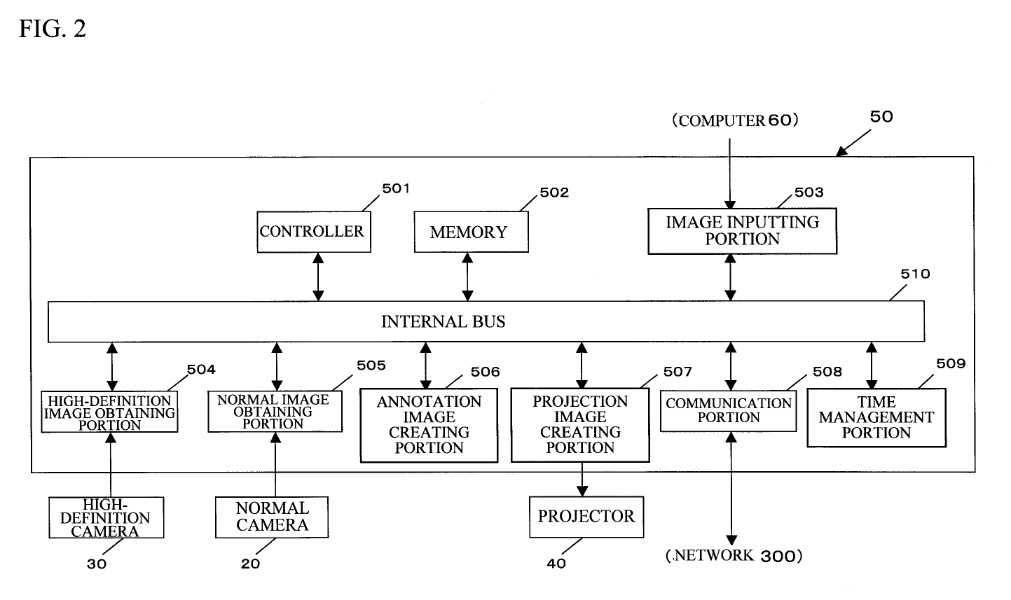

A description will now be given, with reference to the accompanying drawings, of exemplary embodiments of the present invention. FIG. 1 shows a system configuration of a remote instruction system where an image processing system employed in an exemplary embodiment of the present invention is used. FIG. 2 is a functional block diagram of an image processing apparatus. Referring now to FIG. 1, the remote instruction system includes: a normal camera 20 serving as a first image recording portion; a high-definition camera 30 serving as a second image recording portion; a projector 40 serving as a projecting portion; an image processing apparatus 50; a computer 60 serving as a remote apparatus connected to the image processing apparatus 50, which are provided at a target TG side, the target TG being a real object. A white board or a screen may be the target TG. The target also may include both a white board and the other things like products. As an example of a remote maintenance system, a car to be repaired in front of a big screen may be the target TG. In a case of a remote medical system, a human or animal body may be the target TG. The remote instruction system also includes: a computer 100 serving as a terminal apparatus installed at a remote site and coupled to the image processing apparatus 50 via a network 300. Here, FIG. 1 shows only one computer 100 connected through the network 300. However, multiple computers 100 may be connected over the network 300.

The normal camera 20 is composed of, for example, a CCD camera or the like, and is capable of recording the target TG, for example, a whiteboard, at first resolution. Such recorded image is imported into the image processing apparatus 50.

The high-definition camera 30 is composed of, for example, a CCD camera or the like, and is capable of recording the target TG, for example, a white board, at second resolution higher than the first resolution. Such recorded image data is imported into the image processing apparatus 50. The size of the image data obtained by the high-definition camera 30 is greater than that obtained by the normal camera 20 because of a high definition thereof, when the image data of an identical region is recorded. Here, the high-definition camera 30 is so provided as to record a region substantially identical or a region that has a common region to that recorded by the normal camera 20.

The projector 40 is composed of a crystal liquid projector or the like, and projects the image data obtained from the image processing apparatus 50 onto the target TG. The projector 40 is capable of projecting light of the image data onto the region substantially identical or the common region to those recorded by the high-definition camera 30 and the normal camera 20.

The computer 60 is connected by a display apparatus 70, an input device such as a mouse or the like, as shown in FIG. 1. The display apparatus 70 displays image data or the like to output image data from the image processing apparatus 50. A mouse 80 is used for input operation, editing operation of image data, or the like. That is to say, the computer 60 is provided so that the image to be projected onto the target TG from the projector 40 may be input into the image processing apparatus 50.

The computer 100 is connected by a display apparatus 110 such as a crystal liquid display apparatus, CRT, or the like, and an input device such as a mouse 130, and the like. The display apparatus 110 displays image data on a screen for editing the images recorded by the normal camera 20 and recorded by the high-definition camera 30 at the target TG side, or editing the annotation image. The mouse 130 is used for operating various buttons provided on the editing screen, when an instruction related to, for example, the annotation image to be projected onto the target TG is created. By use of the terminal apparatus made up of the computer 100 and the like, a user is able to draw an annotation image, with which an instruction is given to the image, while watching the image of the target TG or the like on the screen of the display apparatus 110.

The operations to create the annotation image with a mouse 120, display apparatus 110, and the computer 100 by the user may be represented as the vector graphics data like the SVG (Scalable Vector Graphics) format in the image processing apparatus 50 and the computers 100 and 60.

Then the annotation image as vector graphics data form rather than a pixel form may be transmitted between the computer 100 and the image processing apparatus 50 through the network 300 to reduce its data size.

The image processing apparatus 50 is capable of making image data from the vector graphics data to pixel data to show image data at the projector 40.

The both of the computers 100 and 60 also have the ability to create image data from the vector graphics data to pixel data to show image data on each of the display apparatuses 110 and 70.

In addition, the vector graphics data may be represented with one of CAD (Computer-Aided Design) formats in compliance with the TSO10303 STEP/AP202 standard or the with another format that is used in a commercial CAD system.

Referring now to FIG. 2, the image processing apparatus 50 includes: a controller 501; a memory 502; an image inputting portion 503; a high-definition image obtaining portion 504; a normal image obtaining portion 505; an annotation image creating portion 506; a projection image creating portion 507; a communication portion 508; a time management portion 509, and the like, which are interconnected to each other so that data can be sent and received by means of an internal bus 510.

The controller 501 is composed of a commonly used Central Processing Unit (CPU); an internal memory; and the like, and controls: the memory 502 of the image processing apparatus 50; the image inputting portion 503; the high-definition image obtaining portion 504; the normal image obtaining portion 505; the annotation image creating portion 506; the projection image creating portion 507; the communication portion 508; the time management portion 509; the internal bus 510; and various data.

The memory 502 is composed of a commonly used semiconductor memory; a disk device; and the like, and retains, accumulates, and stores the data processed in the image processing apparatus 50. Also, the image data retained, accumulated, or stored in the memory 502 can be output to the projector 40, as needed.

The image inputting portion 503 is composed of a commonly used semiconductor memory or the like, and stores the image data after the image data is input from the computer 60. The aforementioned image data can be created by commonly used application software or the like operating on the computer 60.

The high-definition image obtaining portion 504 is composed of a commonly used semiconductor memory or the like, and acquires the image recorded by the high-definition camera 30.

The high-definition camera 30 may obtain digital image data at higher resolution than that of the normal camera 20.

The normal image obtaining portion 505 is composed of a commonly used semiconductor memory or the like, and acquires the image recorded by the normal camera 20.

The normal camera 20 may obtain digital image data at lower resolution than that of the high-definition camera 30.

The annotation image creating portion 506 is composed of a commonly used CPU; an internal memory; and the like, and creates an annotation image by decoding a draw command relating to the annotation image given from a terminal apparatus such as the computer 100 or the like.

The annotation image creating portion 506 is capable of creating the annotation image data from SVG form to pixel form. That is, the annotation image creating portion 506 is capable of interpreting SVG data and render or create graphics data in pixel form.

The projection image creating portion 507 creates an image to be projected from the projector 40. Specifically, the projection image creating portion 507 creates an image to be projected, by use of the image supplied from the image inputting portion 503, the image supplied from the annotation image creating portion 506, the image stored in the memory 502, and the like, as necessary.

The communication portion 508 is composed of: a CPU; a communication circuit; and the like, and communicates with various data that includes the image data and the annotation data between the computer 100, which is a terminal apparatus, via the network 300.

The time management portion 509 is composed of: an internal system clock; a counter; a timer; and the like, and controls process timings and times of: the controller 501; the memory 502; the image inputting portion 503; the high-definition image obtaining portion 504; the normal image obtaining portion 505; the annotation image creating portion 506; the projection image creating portion 507; the communication portion 508; and the internal bus 510.

The internal bus 510 is composed of: a control bus for control; and a data bus for data, and transmits: control data; image data; graphic data; the high-definition image data; and the like.

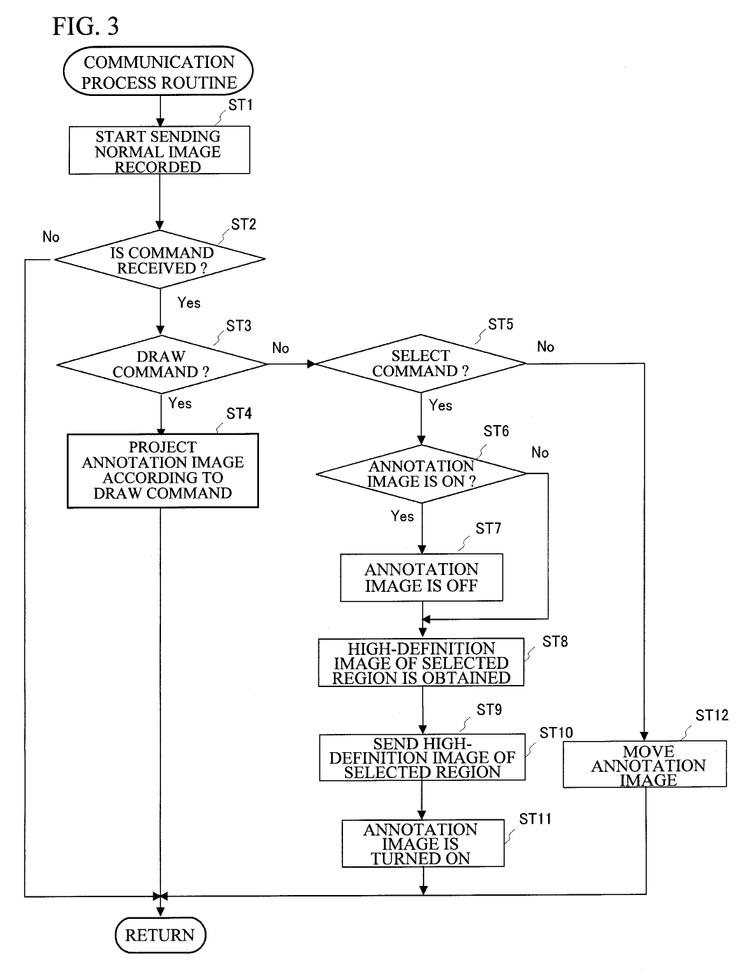

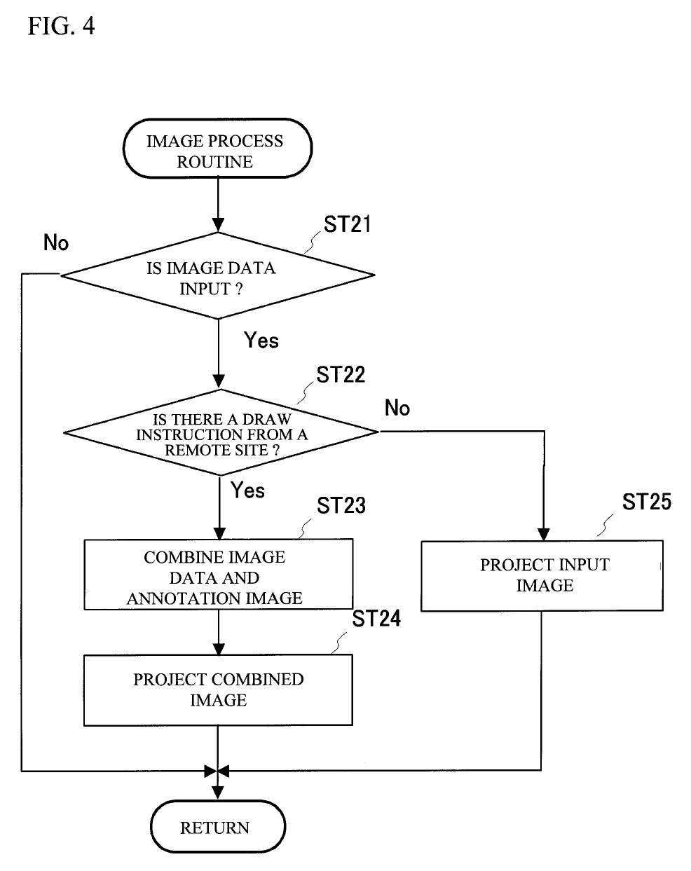

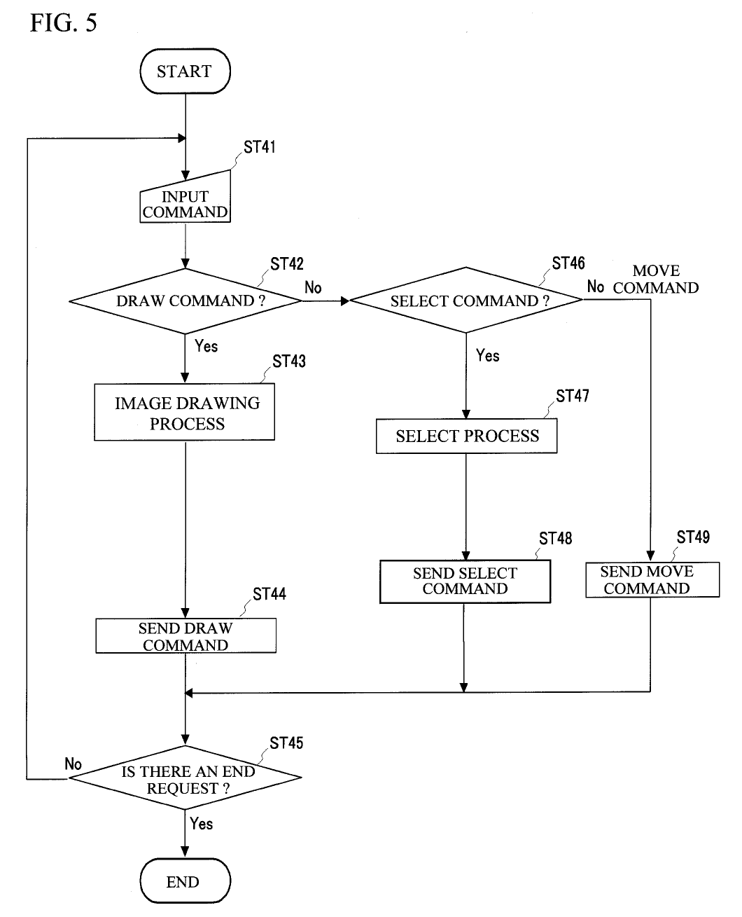

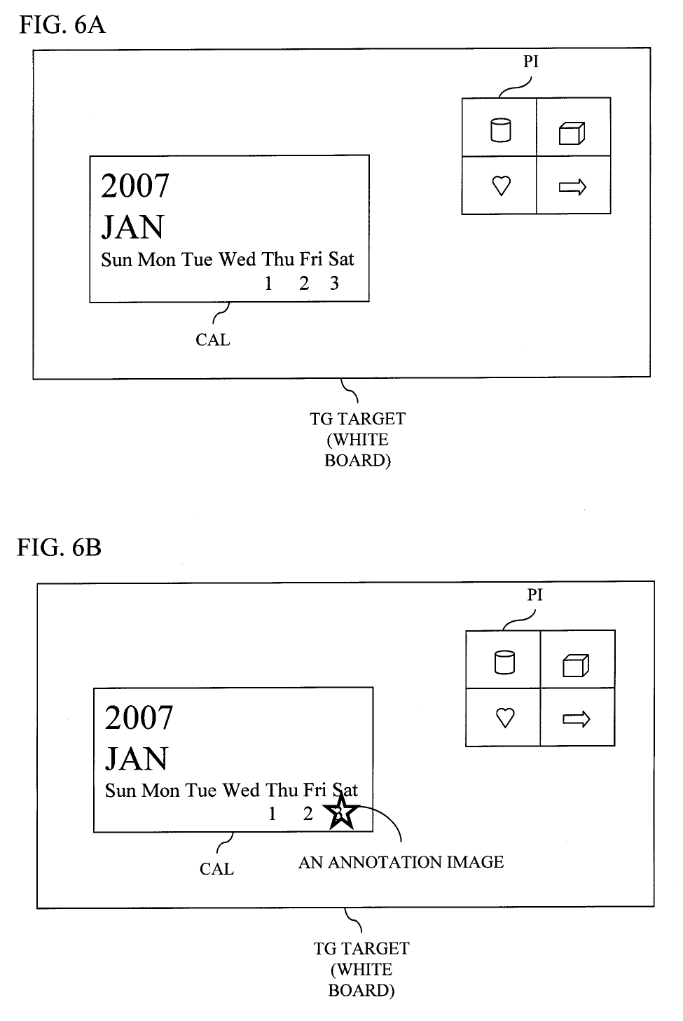

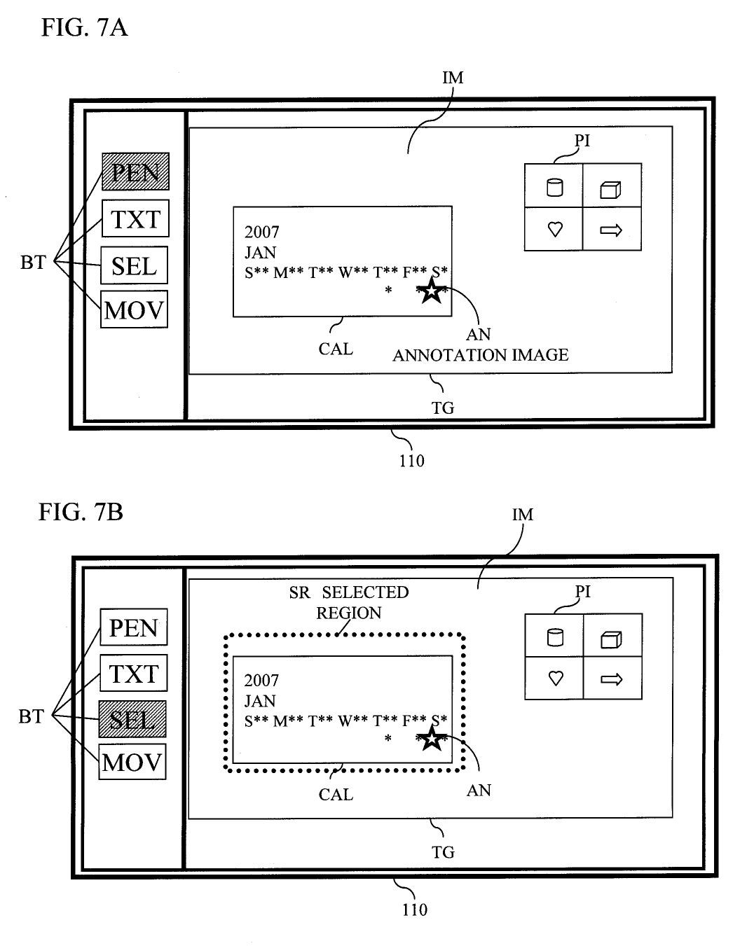

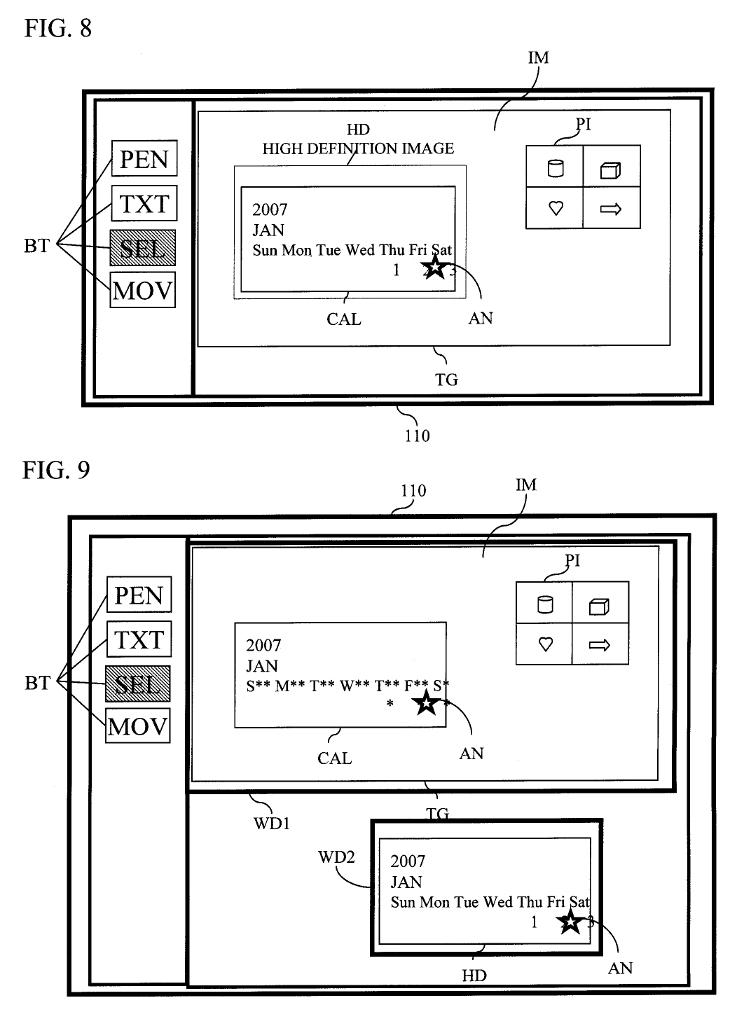

Next, a description will be given, with reference to FIG. 3 through FIG. 9, of an operation example of the remote instruction system. Here, FIG. 3 is a flowchart showing an example of communication processing of the image processing apparatus 50. FIG. 4 is a flowchart showing an example of image processing of the image processing apparatus 50. FIG. 5 is a flowchart showing an example of processing of the computer 100. FIG. 6A and FIG. 6B are views or screen image data or snapshots of the screens showing examples of image data projected onto the target. FIG. 7A and FIG. 7B are views or screen image data or snapshots of the screens showing display examples of a display apparatus at the computer 100 side. FIG. 8 is a view or screen image data or snapshots of the screen showing an example of screen displaying high-definition image data on the display apparatus at the computer 100 side. FIG. 9 is a view or screen image data or snapshots of the screen showing another example of screen displaying the other high-definition image data on the display apparatus at the computer 100 side.

Firstly, a description will be given of the communication processing between the image processing apparatus 50 and the computer 100 through the network 300. The communication processing routine in FIG. 3 may be repeated. The image processing apparatus 50 outputs the image data recorded by the normal camera 20 to the computer 100, as shown in FIG. 3 (step ST1).

Next, the image processing apparatus 50 determines whether or not a command is received from the computer 100 (step ST2). The command may be composed of: for example, a draw command to draw annotation image data; a select command to select a desired region to obtain high-definition image data; a move command to move the annotation image. The other commands like ‘delete’, ‘copy’ and ‘paste’ may be transmitted and performed instead of the move command. Here, the annotation image data is image data for giving an instruction, or an explanation, or additional information and for sharing information between remote sites by use of the image data, and includes any image data such as a graphic image, text image, and the like.

If the draw command is received, a process is performed to project the annotation image data corresponding to the draw command onto the target TG or the white board (step ST3 and step ST4).

In FIG. 6A, the target TG is the white board. And a calendar CAL made of paper is also put on the white board.

FIG. 6B shows the annotation image data AN as a star mark on the calendar.

That is, a user gives a draw command of the star mark with the computer 100.

The image processing apparatus 50 has a function of calibration of positioning or layout between the annotation image data AN and the target TG. For example, the image processing apparatus 50 calibrates the layout between areas to be recorded by the normal camera 20 and the high-definition camera 30 and an area to be projected by the projector 40. This calibration may be done by the geometrical transformation like Affine transformation of image processing.

If the draw command is not received, it is determined whether the select command is received (step ST5). If the select command is received, it is determined whether the annotation image data is projected onto the target TG (step ST6). Then, if the annotation image data is projected onto the target TG, the annotation image data is temporarily deleted (turned off) (step ST7). The annotation image data is temporarily deleted, if the annotation image data is projected onto the target TG, as described. This is because the image processing apparatus 50 does not need to send the annotation image designated at the computer 100 from the image processing apparatus 5 to the computer 100. The computer 100 is capable of retain the annotation image data therein.

In addition, when the high-definition camera 30 records image data, the annotation image data on the target TG might be a noise.

Then the annotation image data is temporarily deleted so that affecting record of image data at high resolution may be avoided by the annotation image data as a noise. In other words, the high-definition camera 30 is capable of recording image data of the target TG without the annotation image data in order to obtain better image data in terms of image quality.

It is easy to compose the both of the image data from the high-definition camera 30 and the annotation image data on the image processing apparatus 5 or on the computer 100 and the computer 60.

Next, the image data recorded by the high-definition camera 30 is acquired (step ST8), described later, the image corresponding to the region selected by the computer 100. The recorded image is sent to the computer 100 (step ST9). When the annotation image is temporarily turned off at step ST7, the annotation image is projected again (step ST11).

At step ST5, if the command is not the select command, the command is determined to be the move command and the annotation image data being projected is moved (step ST12).

The other commands like ‘delete’, ‘copy’, and ‘paste’ may be processed in step ST5 instead of the move command.

Next, a description will now be given of an example of image processing performed by the image processing apparatus 50. The image process routine in FIG. 4 may be repeated by the image processing apparatus 50. The image processing apparatus 50 determines whether the image data is supplied from the computer 60, as shown in FIG. 4 (step ST21). If the image data is supplied, the image processing apparatus 50 determines whether the draw instruction (draw command) of the annotation image data is sent from the computer 100 (step ST22).

If the draw command is not sent, the image obtained from the image data supplied from the computer 60 is projected (step ST25). For example, referring to FIG. 6A, when a projection image data PI created based on the image data supplied from the computer 60, for example, a tiled image data that is created with application software and includes four pieces of picture data from a digital camera, is output from the projector 40 to the target TG of a white board Then, the projection image data PI is projected onto the whiteboard. The projection image data PI can be represented as a pixel form. The normal camera 20 records the scene like FIG. 6A or FIG. 6B, and the recorded image data is sent to the computer 100.

If the draw command has been sent, the image data supplied from the computer 60 and the annotation image data supplied from the computer 100 are combined (step ST23). Such combined image data is projected from the projector 40 (step ST24). For example, when the draw command of the annotation image data is received in the state of FIG. 6A, the projection image data PI supplied from the computer 60 and the annotation image data AN are projected onto the white board like FIG. 6B.

Next, a description will now be given of a process example at the computer 100. On receiving the recorded image data from the image processing apparatus 50, the computer 100 outputs the recorded image data to the display apparatus 110. The image data related to the white board shown in FIG. 6A is displayed on the display apparatus 110 as image data IM as shown in FIG. 7A. At this time, if characters included in the image data IM, especially the calendar CAL have small sizes, it might be difficult to recognize the characters on the screen of the display apparatus 110 for the user. This might occur not only at the characters or the like written in the calendar CAL or the like, but at the projection image PI. However, this often occurs at a physical or real object.

A user at the computer 100 side performs an input operation as needed, while watching the display shown in FIG. 7A. Referring to FIG. 5, the process at this time of the computer 100 will be described. When a user operates various buttons BT formed on the screen of the display apparatus 110 by use of a mouse 120, a command is input (step ST41). Then, it is determined whether or not the command is a draw command to draw the annotation image data (step ST42).

In FIG. 7A, the buttons include a pen button PEN, a text button TXT, a select button SEL, and a move button MOV. The pen button PEN is used to draw annotation image data. The text button TXT is used to type some texts. The select button SEL is used to select a region to record at high resolution with the high-definition camera 30, and the move button MOV is used to move the annotation image data.

When a user operates the various buttons BT or the like on the screen and the draw command is input, the annotation image data AN is drawn on the screen of the display apparatus 110, as shown in FIG. 7B (step ST43). Then, when such input draw command is sent to the image processing apparatus 50 (step ST44) and there is an end request made by the user (step ST45), processing ends.

If the command is not the draw command at step ST42, it is determined whether or not the command is a select command (step ST46). If the command is the select command, the select process is performed to correspond to the select command. Specifically, if the user cannot recognize the characters written in the calendar CAL in the image data IM on the display apparatus 110, each of which is represented as an asterisk ‘*’ in FIG. 7A and FIG. 7B, the user designates a select region SR by operating the mouse 120 or the like and selecting the select button SEL, as shown in FIG. 7B. The select command is input by doing this. Then, the selected region data, namely, data of the select region SR, is sent to the image processing apparatus 50 as such calculated select command (step ST48). Note that the region to record image data with the high-definition camera 30 is calculated to correspond to the selected region data in step ST7 or ST8 in the image processing apparatus 50. At step ST46, if the command is not the select command, it is determined that the move command to move the annotation image data is input by the user. The annotation image data AN on the screen of the display apparatus 110 is moved and the move command is sent to the image processing apparatus 50 (step ST49).

Here, a description will be given of a process example of the computer 100 at the time of sending the select command to the image processing apparatus 50. Referring to FIG. 7B, it is difficult to distinguish small characters or the like in the select region SR. However, the high-definition image data of the region corresponding to the select region SR recorded by the high-definition camera 30 is sent to the computer 100, when the select command is sent to the image processing apparatus 50. Before that, the image processing apparatus 50 superimposes or composes the high-definition image data HD onto the region corresponding to the image data recorded by the normal camera 20.

As another example, as shown in FIG. 9, the computer 100 may display the image data recorded by the normal camera 20 as a display region on a window WD1, and may also display the high-definition image data HD as another display region on another window WD2. Then the image data IM may include the window WD1 and WD2 with the buttons BT on the display apparatus 110.

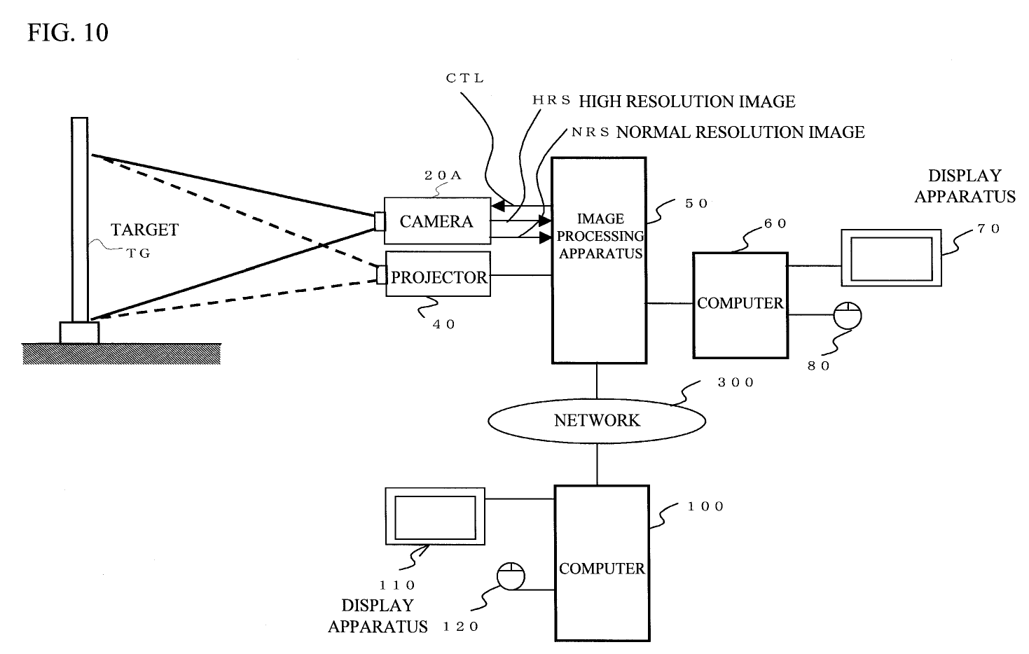

FIG. 10 shows a system configuration of the remote instruction system where an image processing system employed in another exemplary embodiment of the present invention is used. In FIG. 10, the same components and configurations as those employed in the above-described exemplary embodiment have the same reference numerals and a detailed explanation will be omitted. The resolution of a camera 20A for use in the remote instruction system shown in FIG. 10 can be changed according to a control signal CTL supplied from the image processing apparatus 50. High-resolution image data HRS and normal resolution image data NRS are selectively output to the image processing apparatus 50. The image processing apparatus 50 selectively sends the high-resolution image data HRS and the normal resolution image data NRS to the computer 100 or sends composed image data of the high-resolution image data HRS and the normal resolution image data NRS to the computer 100, according to the select signal supplied from, for example, the computer 100. Such configuration enables a similar process to that previously described with the use of a single camera.

The wavelet transform like JPEG 2000 or MPEG-4 systems can be used to obtain image data at lower resolution from original image data at higher resolution. The transformed or encoded image data with the wavelet transform can extract a part of image data at lower resolution from the transformed or encoded image data.

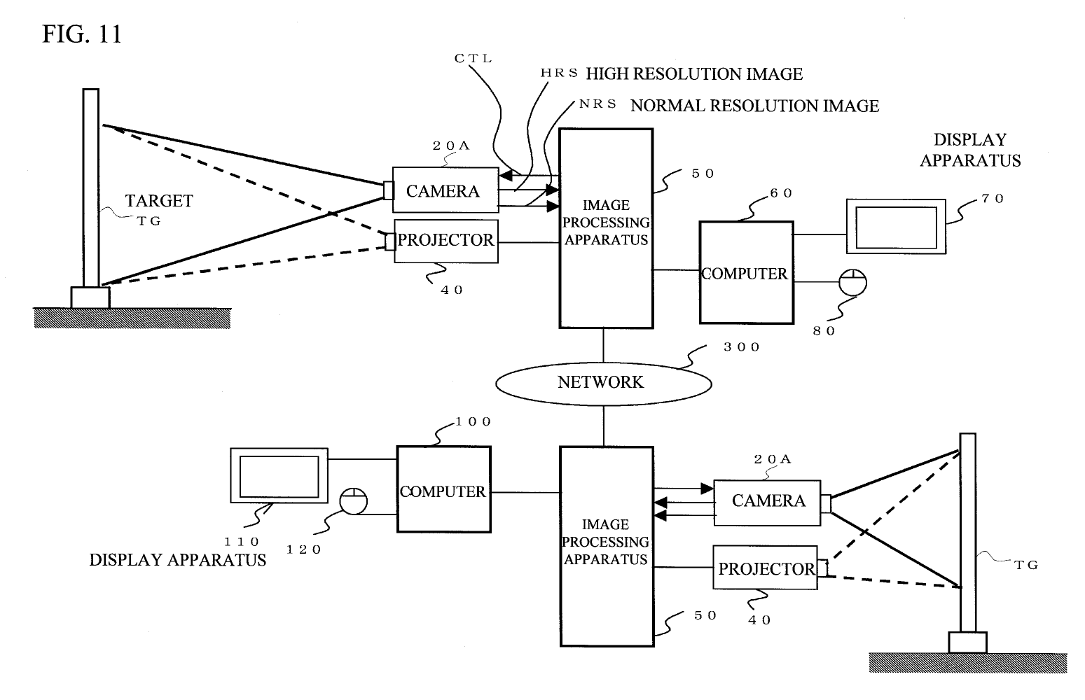

FIG. 11 shows a system configuration of the remote instruction system where an image processing system employed in yet another exemplary embodiment of the present invention is used. In FIG. 11, the same components and configurations as those employed in the above-described exemplary embodiments have the same reference numerals and a detailed explanation will be omitted. In the remote instruction system, two image processing apparatuses 50 are connected via the network 300 to be capable of communicating bidirectionally. Each of the image processing apparatuses 50 is respectively connected by: the above-described camera 20A; the projector 40; the computers 60 and 100; and the like. With such configuration, the computer 60 and the computer 100 can be communicated bidirectionally by use of image data. In accordance with the above-described embodiment, a description has been given of the case where such obtained high-definition image data is displayed on the display apparatus 110 or the like of the computer 100 at a remote site. In addition, the obtained high-definition image data from the other camera 20A is also transmitted to the image processing apparatus 50 over the network 300 and displayed on the other display apparatus 110.

In accordance with an exemplary embodiment previously described, the annotation image data is forcibly turned off when the high-definition image data is obtained. However, the present invention is not limited to this. For example, a period of time while the projector 40 is not projecting the annotation image data can be controlled by use of the time management portion 509, so that the high-definition image data may be obtained during the period.

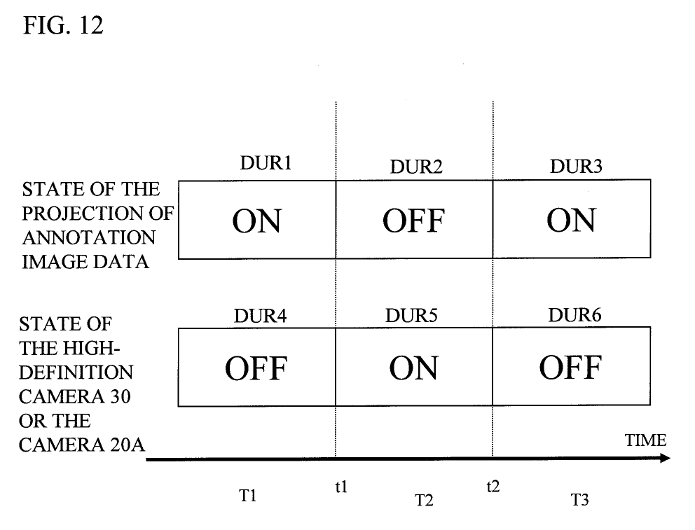

FIG. 12 shows states of projection of annotation image data and the high-definition camera 30 or the camera 20A.

The horizontal axis represents time. In FIG. 12, time is divided into three parts T1, T2, and T3 at the point t1 and t2. Then the state of the projection of annotation image data may include three parts DUR1, DUR2, and DUR3, according to the duration T1, T2, and T3. The state of the high-definition camera 30 or the camera 20A may include three parts DUR4, DUR5, and DUR6, as well. In the state of DUR1 or DUR3, the projector 40 projects the annotation image data. The projector 40 in the state DUR2 does not project the annotation image data.

Meanwhile, in the state of DUR5, the high-definition camera 30 or the camera 20A record image data at high resolution. The high-definition camera 30 or 20A does not record image data in the state DUR4 and DUR6.

Control of the status of the projection of annotation image data and the status of the high-definition camera 30 or the camera 20A may be repeated. For example, DUR1 (ON) and DUR2 (OFF) for the projection of the annotation image data and DUR4 (OFF) and DUR5 (ON) for the recording by the high-definition camera 30 or the camera 20A may be repeated. Then DUR3 (ON) may be thought as a repeat of DUR1. Also DUR6 (OFF) may be regarded as a repeat of DUR4.

The above control may be done electrically by the image processing apparatuses 50, especially with the time management portion 509.

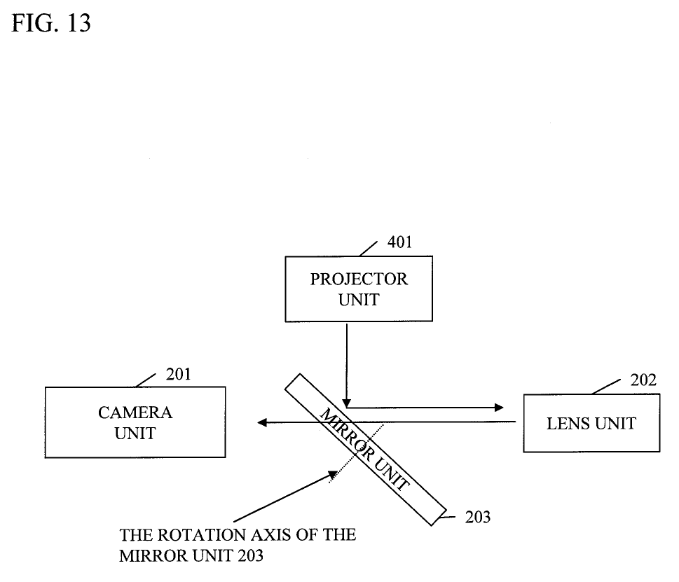

In addition, the above control can be also done physically or mechanically by the time management portion 509 and a specific camera and projector unit in FIG. 13. FIG. 13 shows a configuration of a camera unit 201 and a projector unit 401 to a common lens unit 202. The camera unit 201 and projector unit 401 share the mirror unit 203 and lens unit 202. The light from the target TG goes through the lens unit 202 and mirror unit 203 that has one slit or more slits to pass the light, and the mirror unit reflects the light from the projector unit 401 into the lens unit 202. Then, the light from the projector unit 401 goes out of the lens unit 202.

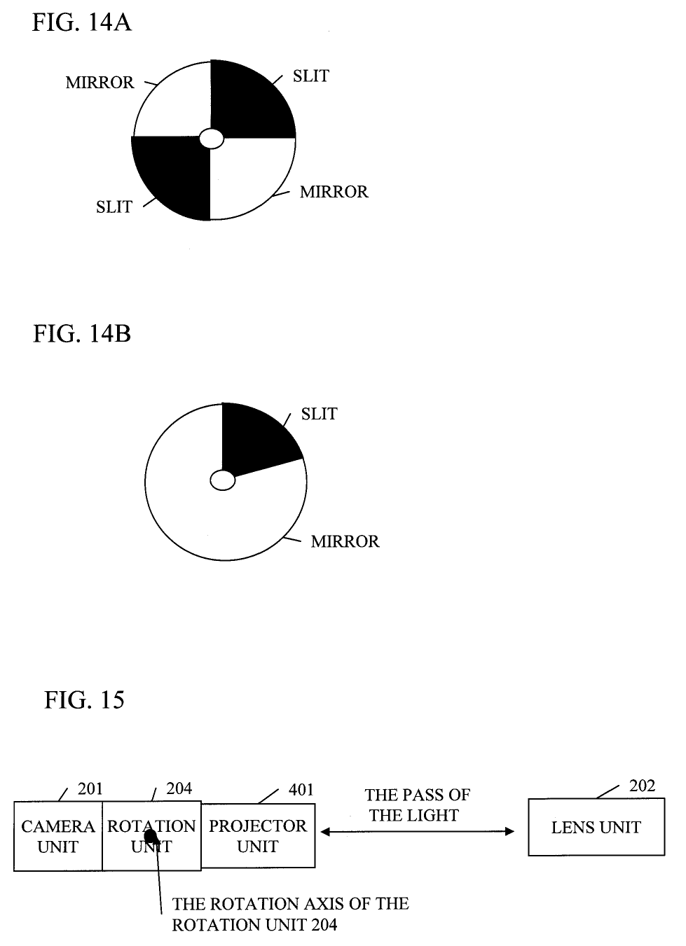

FIG. 14A and FIG. 14B show examples of shape of the mirror unit 203. The mirror unit 203 may have a round shape such as FIG. 14A and FIG. 14B. The center of the mirror unit 203 corresponds to a position of the axis of rotation. The mirror unit 203 in FIG. 14A includes two slit parts and two mirror parts. On the other hand, the mirror unit 203 in FIG. 14B includes one slit part and one mirror part. The slit parts in FIGS. 14A and 14B are shown as black areas. On the other hand, mirror parts in FIGS. 14A and 14B are shown as white areas on the mirror unit 203. The slits of the mirror unit 203 may pass the light from the lens unit 202 into the camera unit 201, and the mirrors of the mirror unit 203 may reflect the light from the projector unit 401 to the lens unit 202.

The time management portion 509 of the image processing apparatuses 50 controls a rotation speed of the mirror unit 203 so that the camera unit 201 obtains the high-definition image data during DUR5 in FIG. 12 and the projector unit 401 projects the annotation image data during DUR1 and DUR3 in FIG. 12.

FIG. 15 shows another configuration of a camera and projector unit with a rotation unit. A rotation unit 204 may be composed with the camera unit 201 and the projector unit 401 as one and rotate around its rotation axis so that the camera unit 201 may obtain the high-definition image data during DUR5 in FIG. 12 and the projector unit 401 may project the annotation image data during DUR1 and DUR3 in FIG. 12. The time management portion 509 of the image processing apparatuses 50 may also control the rotation of the rotation unit 204. The camera unit 201 and the projector unit 401 shares the lens unit 202.

The centers of the passes of the both projected light from the projector unit 401 and captured light by the camera unit 201 are exactly corresponded to each other so that no parallax happens in FIG. 13 or FIG. 15.

In the above-described embodiments, the normal image data and the high-definition image data are selectively sent to the computer at a remote site. The normal image data means image data at normal resolution or lower resolution than the high-definition image data. However, the present invention is not limited to this. For example, a configuration may be employed such that the normal camera 20 and the high-definition camera 30 may be controlled on a time division basis, and the image data recorded by the normal camera 20 and that recorded by the high-definition camera 30 are acquired all the time so as to send to the computer 100 at a remote site. At this time, the transmission frame rate of the high-definition image is made smaller than that of the image data having smaller resolution than the high-definition image data, for example, 60 frames per second. For example, 10 frames are sent every second, thereby controlling the quality thereof. Also, when the high-definition image data is transmitted, the high-definition image and the normal image data may be multiplexed at different frame rates, or may be sent simultaneously at different bands.

As described above, the normal image data and the high-definition image data can be composed or superimposed or multiplexed.

In the above-described embodiments, a description has been given of the case where the normal image data and the high-definition image data are displayed on the common display apparatus 110. However, the display apparatus for the normal image data and that for the high-definition image data may be connected to the computer 100 and may be displayed independently. The normal image data and the high-definition image data may be transmitted over different communication lines, may be multiplexed and transmitted, or may be transmitted on different bands. For example, the normal image data may be transmitted by wireless and the high-definition image data may be transmitted over a (an optical) cable.

In addition, for example, the image data at normal resolution may be assigned to 100 kilobits per second and the high-definition image data may be assigned to 100 megabits per second for transmission, so the communication quality may be controlled. In a similar manner, “so-called” frame rate or a record time interval of the image data at normal resolution may be 30 frames per second and that of the high-definition image data may be one frame per second, so the image quality or the communication quality may be controlled. The transmission system of the normal image data and that of the high-definition image data may have identical protocol or may have different ones. For example, the normal image data may be transmitted by means of so-called HTTP protocol, and the high-definition image data may be so-called FTP protocol.

In the above-described embodiments, the computer 100 or the image processing apparatus 50 may delete the annotation image data and draw the annotation image data again on the display apparatus 110 that shows the image data from the normal camera 20 in order to prevent confusion between projected annotation data that is captured by the normal camera 20 and transmitted to the computer 100 and original drawings that the user draw on the display apparatus 110.

The computer 60 may have the same function of giving an annotation image with the computer 100.

Also the user may provide image data from a digital camera or application software with the computer 100 and the computer 100 may send the image data to the image processing apparatus 50 to project the image data through the projector 40.

If the user does not need to watch the image data in the image processing apparatus 50, the computer 60, the display apparatus 70 and the mouse 80 might not be configured to implement this invention.

An image processing method employed according to an aspect of the present invention is performed with a Central Processing Unit (CPU), Read Only Memory (ROM), Random Access Memory (RAM), and the like, by installing a program from a portable memory device or a storage device such as a hard disc device, CD-ROM, DVD, or a flexible disc or downloading the program through a communications line. Then the steps of program are executed as the CPU operates the program.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

### CROSS-REFERENCE TO RELATED APPLICATIONS

This application is based on and claims priority under 35 USC 119 from Japanese Patent Application No. 2006-251992 filed Sep. 19, 2006.

What is claimed is:

1. An image processing system comprising:
a projecting portion that projects image data;
a first image recording portion that records a projection region of the projecting portion as first image data, at first resolution;
a second image recording portion that records the projection region of the projection portion as second image data, at second resolution, which is higher than the first resolution; and
an image processing portion that sends first image data at the first resolution and second image data at the second resolution to a terminal apparatus and outputs image data to be projected from the terminal apparatus to the projecting portion.

2. The image processing system according to claim 1, wherein the image processing portion selectively sends the first image of the first resolution and the second image of the second resolution to the terminal apparatus, according to an instruction given by the terminal apparatus.

3. The image processing system according to claim 2, wherein the image processing portion sends the second image of the second resolution, the second image showing a region corresponding to the region selected by the terminal apparatus on the basis of the first image of the first resolution.

4. The image processing system according to claim 1, wherein the image processing portion coordinates or calibrates a relative or absolute position or location between the projection region and a recorded region, the projection region and the recorded regions having a common region.

5. The image processing system according to claim 2, wherein the image processing portion obtains the second image data at the second resolution in a state where the annotation image data designated by the terminal apparatus is not projected.

6. The image processing system according to claim 1, wherein the image processing portion normally sends the first image data at the first resolution to the remote apparatus, and sends the second image data at the second resolution to the remote apparatus, only when there is a request made by the remote apparatus.

7. The image processing system according to claim 1, wherein the first image recording portion and the second image recording portion are composed of a commonly provided image recording portion by which resolution of image data to be recorded can be changed.

8. The image processing system according to claim 1, wherein the first image recording portion, the second image recording portion, and the projecting portion are configured to share a lens.

9. An image processing method comprising:
projecting image data;
recording a projection region as first image data at first resolution;
recording the projection region as second image data at second resolution, which is higher than the first resolution;
sending the first image data at the first resolution and the second image data at the second resolution and outputting image data to be projected from the terminal apparatus.

10. A computer readable mediums to ring a program causing a computer to execute a process for image processing, the process comprising:
projecting image data;
recording a projection region as first image data at first resolution;
recording the same projection region or a part of the projection region as second image data at second resolution, which is higher than the first resolution; and
sending first image data at the first resolution and second image data at the second resolution and outputting image data to be projected from the terminal apparatus.
